(19) United States
(12) Patent Application Publication
(10) Pub. No.: US 2018/0046959 A1
(43) Pub. Date: Feb. 15, 2018

(54) SIMILAR PROJECT IDENTIFICATION

(71) Applicant: International Business Machines Corporation, Armonk, NY (US)

(72) Inventors: Sreyash D. Kenkre, Bangalore (IN); Vinayaka Pandit, Bangalore (IN)

(21) Appl. No.: 15/233,067

(22) Filed: Aug. 10, 2016

(51) Int. Cl. G06Q 10/06

(52) U.S. Cl. CPC G06Q 10/06313; G06Q 10/06311

(57) ABSTRACT

One embodiment provides a method, including: utilizing at least one processor to execute computer code that performs the steps of: accessing a project plan comprising a plurality of projects, each having a duration and resource requirement, wherein each of the plurality of projects comprises a plurality of tasks; representing the plurality of projects as a plurality of directed acyclic graphs; clustering a subset of the plurality of directed acyclic graphs into a cluster, wherein the clustering comprises identifying directed acyclic graphs having similar durations and resource requirements; generating a representative directed acyclic graph for the cluster; and providing the representative directed acyclic graph to a user. Other aspects are described and claimed.

### BACKGROUND

Many entities use a planning software tool to generate project plans. The project plans may be used on many different types of projects ranging from small projects, for example, manufacturing a small widget, to large projects, for example, large scale construction, maintenance, engineering, or turnaround projects. These plans may identify different projects that need to be completed in order to achieve the completion of the whole project. Each individual project may have tasks associated with them. These tasks may indicate the activities that need to be completed in order to accomplish the project. As an example, the whole project may be to complete maintenance on a manufacturing facility. Some projects that may need to be completed may include servicing a motor, servicing a pump, checking fluid pipes, and the like. The tasks associated with servicing the motor may include checking the windings, applying new grease, replacing gaskets, and the like.

The project plans not only identify the projects and tasks that need to be completed, but also identify the duration of the projects and/or tasks and resource requirements. Since typical project plans are hierarchically organized, the granularity of the details (e.g., budget, resource requirements, duration, number of tasks, etc.) increase further down in the hierarchy. Project managers and supervisors can then use the project plans to plan resources, time lines, and budgets for the whole project.

### BRIEF SUMMARY

In summary, one aspect of the invention provides a method, comprising: utilizing at least one processor to execute computer code that performs the steps of: accessing a project plan comprising a plurality of projects, each having a duration and resource requirement, wherein each of the plurality of projects comprises a plurality of tasks; representing the plurality of projects as a plurality of directed acyclic graphs; clustering a subset of the plurality of directed acyclic graphs into a cluster, wherein the clustering comprises identifying directed acyclic graphs having similar durations and resource requirements; generating a representative directed acyclic graph for the cluster; and providing the representative directed acyclic graph to a user.

Another aspect of the invention provides an apparatus, comprising: at least one processor; and a computer readable storage medium having computer readable program code embodied therewith and executable by the at least one processor, the computer readable program code comprising: computer readable program code that accesses a project plan comprising a plurality of projects, each having a duration and resource requirement, wherein each of the plurality of projects comprises a plurality of tasks; computer readable program code that represents the plurality of projects as a plurality of directed acyclic graphs; computer readable program code that clusters a subset of the plurality of directed acyclic graphs into a cluster, wherein the clustering comprises identifying directed acyclic graphs having similar durations and resource requirements; computer readable program code that generates a representative directed acyclic graph for the cluster; and computer readable program code that provides the representative directed acyclic graph to a user.

An additional aspect of the invention provides a computer program product, comprising: a computer readable storage medium having computer readable program code embodied therewith, the computer readable program code executable by a processor and comprising: computer readable program code that accesses a project plan comprising a plurality of projects, each having a duration and resource requirement, wherein each of the plurality of projects comprises a plurality of tasks; computer readable program code that represents the plurality of projects as a plurality of directed acyclic graphs; computer readable program code that clusters a subset of the plurality of directed acyclic graphs into a cluster, wherein the clustering comprises identifying directed acyclic graphs having similar durations and resource requirements; computer readable program code that generates a representative directed acyclic graph for the cluster; and computer readable program code that provides the representative directed acyclic graph to a user.

A further aspect of the invention provides a method, comprising: accessing a project plan comprising a plurality of projects, each project comprising a plurality of tasks, each task comprising a duration and a resource requirement; representing each project as a directed acyclic graph wherein a task within the project is represented as a node and a constraint associated with a task within the project is represented as an edge in the directed acyclic graph; grouping the directed acyclic graphs within groups, wherein the directed acyclic graphs have similar characteristics; generating a representative directed acyclic graph for each of the groups of directed acyclic graphs.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of similar project identification.

FIG. 2 illustrates an example directed acyclic graph.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

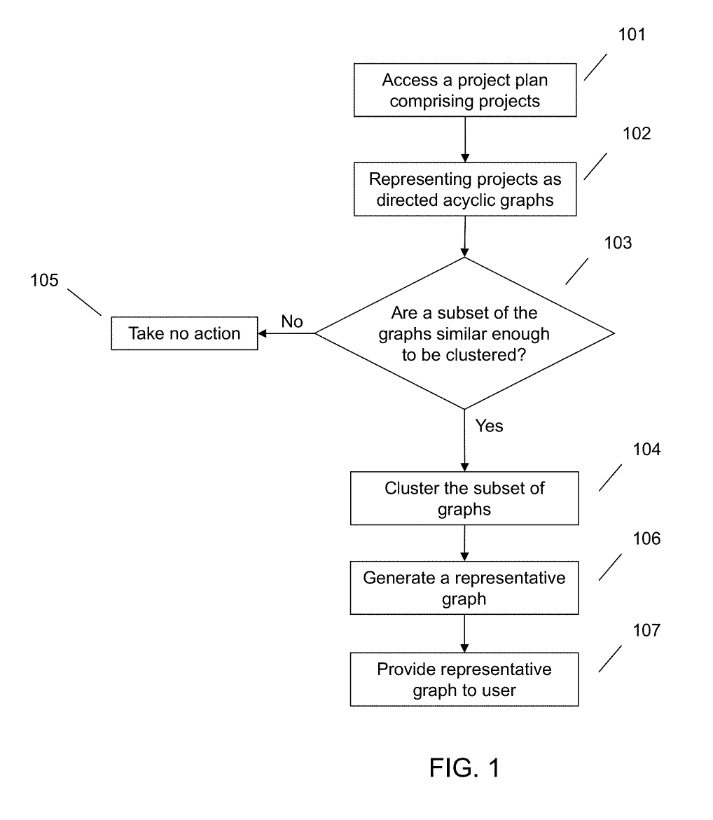

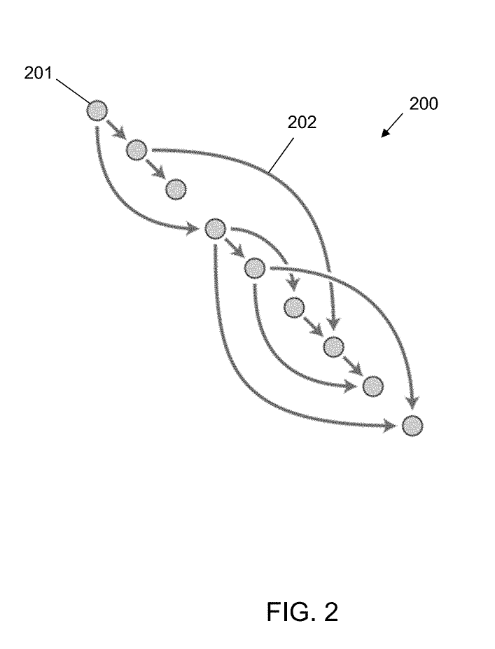

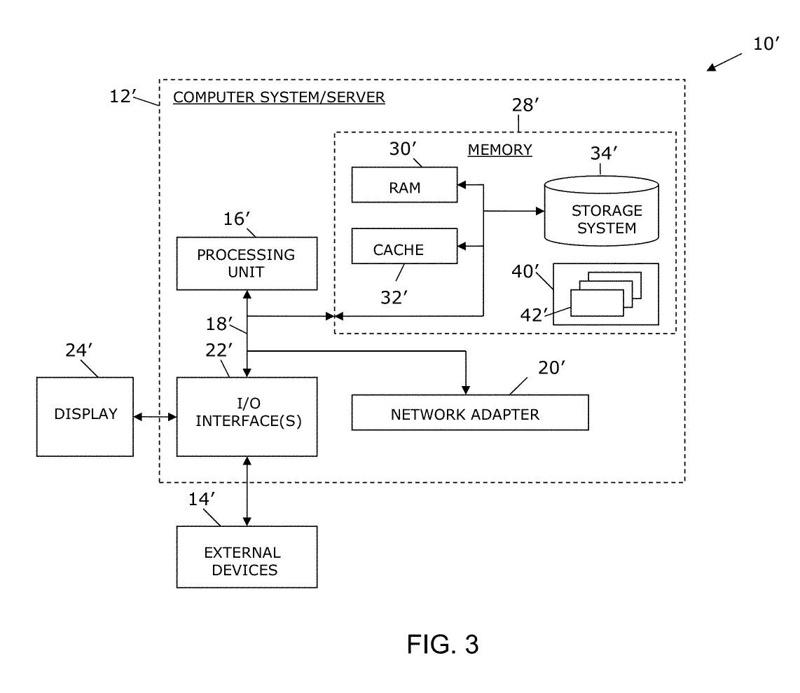

Specific reference will be made here below to FIGS. 1-2. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

Due to the large amount of detail that is required to generate a project plan, many different users may provide information for the project plan. For example, a project manager for one of the projects may provide the plan information for that project including the budget, resource requirements, duration, constraints, and the like. For a different project, a different project planner may provide the plan information. The problem with this is that some of the projects may be similar between different departments or groups, but the users may provide different input. For example, two departments may need to perform maintenance on a motor. However, one user providing the input has completed fifty similar maintenance projects and is, thus, providing accurate information based upon past experience. The other user may have never completed a maintenance project and is, thus, providing information that is merely a guess and may be very inaccurate.

Some project planning and/or scheduling tools may allow for a consistency check across groups of similar activities. However, such consistency checks are limited to checking for consistent resources and time requirements. Additionally, these checks cannot be completed across an entire project plan. Rather, the consistency checks are limited to activities which have been identified as similar by a user within a single project group (e.g., work breakdown structure (WBS), project team, department, etc.). Thus, current project planning and scheduling tools do not provide for or complete an analysis of the information at the lower levels of the project plan across the entire project plan. Therefore, inconsistencies may occur which may contribute to schedule and cost overruns.

Accordingly, an embodiment provides a method of identifying similar projects within an entire project plan and providing a method for applying consistent plans for the projects. To identify similar projects an embodiment may first access a project plan having a plurality of projects each having duration and resource requirements and tasks. The duration and resource requirements may be applied to the project, to the tasks, or to both. The projects may then be represented as directed acyclic graphs. The tasks or activities may be represented as a node in the directed acyclic graph and the constraints may be represented as an edge in the graph.

Once the projects within the project plan have been represented as directed acyclic graphs, an embodiment may cluster a subset of the graphs into a cluster. When clustering the graphs, an embodiment may identify graphs having similar duration and resource requirements. In one embodiment the descriptions, as included within the nodes (e.g., the description of the tasks that need to be completed, etc.), are also analyzed to determine whether the graphs are similar. Identifying similar graphs may include using a similarity measure, using a shingling technique, a combination of techniques, or the like. Once similar graphs have been clustered into one or more clusters, an embodiment may generate a representative directed acyclic graph for the cluster. One embodiment may identify the graph within the cluster that is the longest or has the most nodes. This may be used as the base for the representative graph. An embodiment may then assign resource requirements and durations to each of the nodes within the representative graph.

In one embodiment to assign the requirements, an embodiment may average the information from the corresponding nodes within the cluster. As an example, the representative graph may represent performing maintenance on a motor. The nodes may include “checking windings”, “replacing gaskets”, “applying grease”, and “cleaning the motor”. Not all the graphs within the cluster may include a “checking the windings” node. However, since some of the graphs do include a node for “checking the windings”, the representative graph may include a node corresponding to the activity of “checking the windings”. To assign the resource and duration requirements an embodiment may capture the information for the node “cleaning the motor” from all the graphs. This information may then be averaged. For example, if five graphs are included within the cluster and the time durations for the “cleaning the motor” nodes include three hours, three hours, five hours, two hours, and two hours, an embodiment may assign a duration of three hours to the representative graph node corresponding to “cleaning the motor”.

Once the representative graph has been generated it may be provided to the user for use in current or future project plans. In one embodiment, projects within the project plan may be replaced with the corresponding representative graph. This may help ensure consistency across the entire project including different project groups. In one embodiment the projects in the project plan may be compared against the representative graph to check for inconsistencies or outliers within the project plan. The representative graph may be used to check for currently-in-process projects. For example, as a project within the plan is being completed, the progress of the project may be compared against the representative graph. If the project is deviating from the representative graph, a user can be notified. Thus, the representative graph can be used during the planning and execution phases of the project.

Such a system provides a technical improvement over current project planning or scheduling systems in that the system is able to check for consistency of similar projects across the entire project plan, including different branches of the project plan. The system as described herein provides a method for identifying similar projects and generating a representative graph for these similar projects. The representative graph can then be used during the planning phase of the project to ensure that similar projects have consistent information. Additionally, embodiments can identify projects that have been included within the project plan that have significant deviations from the representative graph. The representative graph can also be used in the execution phase of a project to ensure that projects are progressing as expected. Thus, the systems as described herein provide a method for ensuring consistent data across an entire project plan, which may reduce cost and schedule overruns that is not possible with current project planning and scheduling methods and systems.

Referring now to FIG. 1, at 101 an embodiment may access a project plan having a plurality of projects. Accessing the project plan may include capturing the information from another system. For example, the system as described herein may be a standalone system that can access project planning or scheduling tools to capture the information included within the planning or scheduling tool. Accessing the project plan may also include receiving the information. For example, a user may upload the project plan into the system. In one embodiment the system as described herein may be an add-on or plug-in to a project planning or scheduling tool. Thus, when a user provides information into the planning or scheduling tool the system may also receive the information being provided.

The projects within the project plan may include tasks representing activities that are required to be completed in order to complete the project. The projects within the project plan may each have a duration and resource requirement associated with them. The projects may also include additional information, for example, budget, time lines, constraints, and the like, which may be used by the system. The requirements associated with projects may be associated at a project level, at a task level (e.g., each task has a duration and resource requirement associated with it), or at both a project and task level. Different projects within the project plan may have the requirements provided in different ways. For example, for one project the requirements may be at a project level and for another project the requirements may be at a task level.

At 102 an embodiment may represent each of the projects as a directed acyclic graph, for example, as shown in FIG. 2. The tasks within the project may be represented as a node 201 within the graph 200. Constraints (e.g., Task A cannot be completed before Task B) may be represented as edges 202 within the graph 200. As can be understood, the graph shown in FIG. 2 is merely an example. A directed acyclic graph can be represented in many different forms and may include more or fewer nodes and/or constraints. For example, the nodes may be represented as boxes rather than circles. Each node within the graph may include requirement information. For example, the node may include resource requirements, budget requirements, task duration, and the like. The node information may also include a description of the task to be performed. The description may be a short or detailed description. Any constraints or dependencies associated with a node may be represented as an edge or directed arc within the graph. For example, if the task represented by Node A has be to be completed before the task represented by Node D, an arrow, directed arc, edge, etc., may be provided between Node A and Node D.

For projects where the requirement information was provided at a project level, the requirement information may be cascaded through the nodes. Cascading the requirement information throughout the individual tasks may be different for different requirements. For example, for resources the resources as provided at the project level may be assigned to each node (e.g., if the project level resource is three, the node level resource will be three). As another example, the duration requirement may be divided among the nodes (e.g., if the project level duration is ten hours, the duration for each of the ten nodes included in the project may be one hour). The allocation of requirements may be completed in different ways, for example, a user may be requested to provide the information, the information may be pulled from similar activities, and the like.

Once the projects within the project plan have been represented as directed acyclic graphs, an embodiment may identify whether a subset of the graphs are similar enough to be clustered at 103. Similar graphs may be identified across any portion of the project plan. In other words, similar graphs do not have to be within the same project branch, on the same hierarchical level, and the like. An embodiment may define or use a similarity measure to determine graphs that are similar. For example, the similarity measure may include determining if the graphs have the same number of nodes, constraints, requirements, and the like. The similarity measure may include a function that defines the similarity between two objects, for example, Jaccard similarity measure, an affinity measure, or other clustering similarity measures.

Similar graphs may be designated as graphs having similar structures, for example, similar dependencies or constraints, similar nodes, and the like. Similar graphs may not only use the graph structure, but may also be identified using the node content (e.g., description, requirements, etc.). Thus, graphs having similar structures but different job descriptions may be treated as different. For example, a graph for maintaining a pump having three nodes, where both Nodes B and C are dependent on Node A, may be treated as being different than a graph for installing windows having the same structure. Conversely, graphs having different structures but which represent similar tasks may be treated as being similar. For example, a graph for maintenance of a motor having three nodes may be treated as being similar to a graph for maintenance of a motor having four nodes.

For ease of understanding, the graphs have been described as only having few nodes. However, it should be readily understood that the systems and methods as described herein can be used for graphs of any size, for example, graphs having hundreds of nodes and constraints.

To identify nodes having similar descriptions an embodiment may employ different methods. For example, one embodiment may simply parse and compare words within the description of the nodes. If a predetermined number of words match, an embodiment may consider the descriptions as being similar. Another method is to use a shingling technique to identify similar clusters. In the shingling technique a parameter is identified, for example, a string length. The parameter may then be applied to the description included within the node, resulting in strings all having the length of the parameter. Sets of shingles are then constructed out of the strings. The frequency of the set of shingles is then associated with the set of shingles. A similarity measure, as described above, can then be used to group the tasks based upon the similarity of the sets. Other methods for identifying nodes having similar descriptions are possible, for example, string matching, graph isomorphism, and the like.

If there are not enough graphs to be grouped or clustered into a subset at 103, an embodiment may take no action at 105. Alternatively, an embodiment may prompt the user to provide different parameters for completing the grouping. If, however, there are enough graphs to be grouped at 103, an embodiment may cluster or group a subset of the graphs into a cluster or group at 104. The clusters may include graphs having similar durations, resource requirements, and/or descriptions as described above.

In one embodiment the graphs may be clustered and an outlier may be identified. For example, the graphs may be clustered and the system may identify that 10% of the clusters include durations that are twice as long as the remaining 90% of the clusters. In this case, the system may notify a user of the discrepancy. The user may then determine whether the projects represented by the 10% of the cluster should be modified. For example, the user may notify the user providing the project information that the information provided is significantly different than information provided by other users having similar projects.

Alternatively, the user may determine that the cluster needs to be modified. For example, a user may identify that finer partitioning of a cluster is required. As an example, a user may identify that similar projects have been clustered due to the graph structure and descriptions. However, the user may additionally identify that the cluster includes two distinct projects, for example, installing exterior windows and installing interior windows. Each of these projects has the same tasks; however, the user may identify that the equipment requirements are substantially different for the projects. Thus, the user may provide input to the system to split the cluster into two clusters representing the two different projects.

The user may manipulate the clusters in other ways. For example, a user may generate a sub-cluster from the identified cluster. The sub-cluster may represent a critical project path that is represented by a small group of the tasks within the cluster. The user may then identify this group and the system may generate the requested sub-cluster. A user can also associate additional information with the cluster. For example, the user may designate the cluster as a high value activity, identify tasks which may become critical, identify hazardous activities, and the like.

Once the graphs have been clustered, an embodiment may generate a representative directed acyclic graph for the cluster at 106. In one embodiment the representative graph may include the most common nodes, constraints, durations, resource requirements, and other requirements, as identified within the cluster. For example, if the most commonly occurring graph within the cluster has four nodes with one hour long durations, this may be used as the representative graph. In one embodiment the representative graph may be based upon the longest graph within the cluster. The longest graph may be determined by the graph having the most nodes or the most complex graph. Each of the nodes within the graph may be assigned requirement values (e.g., duration, resource requirements, budget, timelines, etc.) that are based upon an average of the nodes within the cluster of graphs. For example, if the duration for the nodes of the cluster represented by Node A in the representative graph averages four hours, this value may be used for the representative graph.

Other techniques or combinations of these techniques may be used to generate the representative graph. For example, the most commonly occurring graph structure may be used, but the resource requirements for each of the nodes within that graph may be based upon the average of the nodes within the cluster of graphs. The nodes may also include ranges rather than an exact number. For example, rather than a duration of one hour, the node may include a duration of from thirty minutes to ninety minutes. Representative graphs may be generated not only using the projects contained within this project plan, but may be generated using projects from previous project plans, for example, completed projects, previously submitted project plans, and the like.

The representative graph may then be provided to the user at 107. Providing the graph to the user may include displaying it on a display device for review by the user, storing it in a storage location (e.g., local storage device, remote storage device, cloud storage device, etc.) for use at a later time, and the like. The user may then manipulate the representative graph if desired. For example, the user may remove nodes, change requirements, and the like. The representative graph may be used in the planning phase of a project. For example, projects within a project plan may be replaced with the corresponding representative graph. When a user is providing input for a project plan, the user may select the representative graph for insertion into the project. The user can then manipulate the representative graph to account for the specifics of the desired project. For example, the user may not need all the nodes that are included with the representative graph and may, thus, remove the nodes that are not required within the project.

The representative graph may also be used to generate risk and performance metrics. For example, the representative graph may be used as the standard by which the projects are measured. For example, when a user provides input to a project plan for a project that is similar to the representative graph, if the input deviates from the representative graph, the user may be notified. As another example, if a project has been identified as deviating from the representative graph and the user confirms that the deviation is correct, the project team may determine if the deviation should be addressed by, for example, adding more resources.

Deviations may be exact deviations, for example, the project is a single minute over the expected duration, or they may be deviations of a predetermined amount. For example, the graphs may have a range associated with them, for example, the resource requirement can change by one person. The user may also set up notifications that notify the user if the deviations are of a predetermined amount. Deviations may be different for different projects. For example, the deviation tolerance for a high risk or critical project may be less than the deviation tolerance for a less critical project.

The representative graph may also be used during the execution phase of a project. As projects within the project plan are being completed a user may provide input to the project plan identifying the progress of the project. The system or a user may then compare this progress against the representative graph. If the progress deviates from the representative graph, a user may be notified of the deviation. In other words, the system may identify a project outside a predetermined tolerance as compared with the representative graph. The representative graph may also be updated as projects get completed. For example, if a majority of projects corresponding to the representative graph have been completed with durations much shorter than the duration as identified within the representative graph, the duration of the representative graph may be reduced.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
utilizing at least one processor to execute computer code that performs the steps of:
accessing a project plan comprising a plurality of projects, each having a duration and resource requirement, wherein each of the plurality of projects comprises a plurality of tasks;
representing the plurality of projects as a plurality of directed acyclic graphs;
clustering a subset of the plurality of directed acyclic graphs into a cluster, wherein the clustering comprises identifying directed acyclic graphs having similar durations and resource requirements;
generating a representative directed acyclic graph for the cluster; and
providing the representative directed acyclic graph to a user.

2. The method of claim 1, wherein the representing the plurality of projects comprises representing each of the plurality of tasks as a node of the directed acyclic graph and a constraint associated with a task as an edge of the directed acyclic graph.

3. The method of claim 1, wherein the clustering comprises identifying directed acyclic graphs having similar task descriptions.

4. The method of claim 3, wherein the identifying directed acyclic graphs having similar task descriptions comprises using a shingling technique to identify similar task descriptions.

5. The method of claim 1, wherein the clustering comprises identifying similar directed acyclic graphs using a similarity measure.

6. The method of claim 1, wherein the generating a representative directed acyclic graph comprises:
identifying the longest directed acyclic graph within the cluster;
averaging the resource requirements and duration for each task within the cluster; and
assigning the average resource requirement and duration to the tasks within the longest directed acyclic graph.

7. The method of claim 1, comprising identifying at least one directed acyclic graph in the cluster representing an outlier within the cluster of directed acyclic graphs.

8. The method of claim 1, comprising replacing a project within a project plan with a corresponding representative directed acyclic graph.

9. The method of claim 1, comprising identifying a project within a project plan outside a predetermined tolerance as compared to a corresponding representative directed acyclic graph.

10. The method of claim 1, comprising generating a sub-cluster from the cluster, based upon user input, and wherein the representative cluster is generated from the sub-cluster.

11. An apparatus, comprising:
at least one processor; and
a computer readable storage medium having computer readable program code embodied therewith and executable by the at least one processor, the computer readable program code comprising:
computer readable program code that accesses a project plan comprising a plurality of projects, each having a duration and resource requirement, wherein each of the plurality of projects comprises a plurality of tasks;
computer readable program code that represents the plurality of projects as a plurality of directed acyclic graphs;
computer readable program code that clusters a subset of the plurality of directed acyclic graphs into a cluster, wherein the clustering comprises identifying directed acyclic graphs having similar durations and resource requirements;
computer readable program code that generates a representative directed acyclic graph for the cluster; and
computer readable program code that provides the representative directed acyclic graph to a user.

12. A computer program product, comprising:
a computer readable storage medium having computer readable program code embodied therewith, the computer readable program code executable by a processor and comprising:
computer readable program code that accesses a project plan comprising a plurality of projects, each having a duration and resource requirement, wherein each of the plurality of projects comprises a plurality of tasks;
computer readable program code that represents the plurality of projects as a plurality of directed acyclic graphs;
computer readable program code that clusters a subset of the plurality of directed acyclic graphs into a cluster, wherein the clustering comprises identifying directed acyclic graphs having similar durations and resource requirements;
computer readable program code that generates a representative directed acyclic graph for the cluster; and
computer readable program code that provides the representative directed acyclic graph to a user.

13. The computer program product of claim 12, wherein the representing the plurality of projects comprises representing each of the plurality of tasks as a node of the directed acyclic graph and a constraint associated with a task as an edge of the directed acyclic graph.

14. The computer program product of claim 12, wherein the clustering comprises identifying directed acyclic graphs having similar task descriptions.

15. The computer program product of claim 14, wherein the identifying directed acyclic graphs having similar task descriptions comprises using a shingling technique to identify similar task descriptions.

16. The computer program product of claim 12, wherein the clustering comprises identifying similar directed acyclic graphs using a similarity measure.

17. The computer program product of claim 12, wherein the generating a representative directed acyclic graph comprises:
identifying the longest directed acyclic graph within the cluster;
averaging the resource requirements and duration for each task within the cluster; and
assigning the average resource requirement and duration to the tasks within the longest directed acyclic graph.

18. The computer program product of claim 12, comprising identifying at least one directed acyclic graph in the cluster representing an outlier within the cluster of directed acyclic graphs.

19. The computer program product of claim 12, comprising identifying a project within a project plan outside a predetermined tolerance as compared to a corresponding representative directed acyclic graph.

20. A method, comprising:
accessing a project plan comprising a plurality of projects, each project comprising a plurality of tasks, each task comprising a duration and a resource requirement;
representing each project as a directed acyclic graph wherein a task within the project is represented as a node and a constraint associated with a task within the project is represented as an edge in the directed acyclic graph;
grouping the directed acyclic graphs within groups, wherein the directed acyclic graphs have similar characteristics;
generating a representative directed acyclic graph for each of the groups of directed acyclic graphs.
